(19) United States
(12) Patent Application Publication
(10) Pub. No.: US 2023/0353587 A1
(43) Pub. Date: Nov. 2, 2023

(54) Contextual relationship graph based on user's network transaction patterns for investigating attacks

(71) Applicant: Zscaler, Inc., San Jose, CA (US)

(72) Inventors: Loc Bui, San Jose, CA (US); Douglas A. Koch, Santa Clara, CA (US); Matthew Cronin, Nashville, TN (US); Shudong Zhou, Fremont, CA (US); Miao Zhang, Sunnyvale, CA (US); Dianhuan Lin, Sunnyvale, CA (US); Rex Shang, Los Altos, CA (US); Howie Xu, Palo Alto, CA (US); Nirmal Singh Bhary, Mohali (IN); Deepen Desai, San Ramon, CA (US); Narinder Paul, Sunnyvale, CA (US); Parnit Sainion, San Jose, CA (US); Kenneth Sigafoose, Austin, TX (US); Bryan Lee, San Jose, CA (US); Josh Pyorre, Portland, OR (US); Martin Walter, Livermore, CA (US); Atinderpal Singh, Surrey (CA); Brett Stone-Gross, Santa Barbara, CA (US); Erik Yunghans, Moretown, VT (US)

(21) Appl. No.: 17/874,896

(22) Filed: Jul. 27, 2022

(30) Foreign Application Priority Data
May 2, 2022 (IN) 202211025523

(51) Int. Cl. H04L 9/40; G06F 16/901

(52) U.S. Cl. CPC H04L 63/1425; H04L 63/1433; G06F 16/9024; H04L 63/1416

(57) ABSTRACT

Systems and methods include receiving network transaction data for a plurality of users monitored by a cloud-based system; creating a relationship graph based on the plurality of user's recent network transactions for a time period, wherein the relationship graph includes vertices for domains and edges for transactions by users between the domains having some number of transaction in the time period; and analyzing the relationship graph to detect previously undetected suspicious anomalies. The weights on each edge are based on a relationship between two domains where the relationship includes any of malware, Internet Protocol (IP) addresses, Autonomous System Number (ASN), registration, and redirects.

### FIELD OF THE DISCLOSURE

The present disclosure generally relates to computer networking systems and methods. More particularly, the present disclosure relates to systems and methods for a contextual relationship graph based on user's network transaction patterns for investigating attacks.

### BACKGROUND OF THE DISCLOSURE

The cyberthreat landscape continues to grow progressively worse by the day. More and more sophisticated attacks are spotted in the wild, and security teams are scrambling to keep up. There are many new types of issues we face—advanced phishing attacks are proving all too successful, and ransomware is a common form of malware organizations seem helpless to protect against. In addition, the number of endpoints that need protection is too big and the endpoints themselves too widespread, and attackers use this reality to target insecure end users.

Yesterday's signature-based detection tools are failing us more often than ever. Traditional antivirus signatures are proving less effective as more advanced attackers are capable of morphing their code and indicators of compromise to evade signature-based methods. Furthermore, signature-based detection is always a “race condition,” where vendor analysts need to develop signatures and push them out to customers to meet a deadline. Last but not least, many attacks do not leverage malware at all—savvy attackers may move laterally within network environments from host to host, and attackers use well-known system tools like PowerShell to avoid detection.

Once a compromise has occurred, attackers attempt to maintain a persistent presence within the victim's network, escalate privileges, and move laterally to extract sensitive information from locations under the attacker's control. The Lockheed Martin “Kill Chain” is an industry mod& for an attack lifecycle that includes the stages of 1) reconnaissance, 2) weaponization, 3) delivery, 4) exploitation, 5) installation, 6) C2, and 7) action. Also, another well-documented industry model that describes an attack campaign and its phases is MITRE's ATT&CK, which focuses on the specific internal mechanics of an attack beyond the reconnaissance and weaponization phases of the kill chain. Those skilled in the art will recognize there are various other models, each of which is contemplated herewith, and each of which includes stages. Detecting the attack is often at the later stages of the attack.

Stopping attacks is difficult as attack techniques are constantly changing. For organizations trying to leverage signatures and typical indicators of compromise (IOCs), security detection and prevention is a constant game of “whack-a-mole” if the usual simple indicators are used alone. Preventing all reconnaissance, delivery, and exploitation attempts is likely unrealistic—we should keep trying, of course, but we should also be pragmatic and assume that eventually some initial attack stages will succeed.

In many cases, we want to investigate further: Is there anything else going on related to these activities? Are these parts of a bigger campaign? Who are the threat actors?

### BRIEF SUMMARY OF THE DISCLOSURE

The present disclosure relates to systems and methods for a contextual relationship graph based on user's network transaction patterns for investigating attacks. Specifically, the present disclosure utilizes logs from cloud-based monitoring to build contextual relationship graphs to look at user's network transaction patterns. Once an attack is detected, it is possible to go backwards in time and analyze the patter using the relationship graphs.

Systems and methods include steps of receiving network transaction data for a plurality of users monitored by a cloud-based system; creating a relationship graph based on the plurality of user's recent network transactions for a time period, wherein the relationship graph includes vertices for domains and edges for transactions by users between the domains having some number of transaction in the time period; and analyzing the relationship graph to detect previously undetected suspicious anomalies. Weights on each edge can be based on a relationship between two domains where the relationship includes any of malware, Internet Protocol (IP) addresses, Autonomous System Number (ASN), registration, and redirects.

The steps can further include creating the relationship graph for each of a plurality of time periods; and analyzing the relationship graph over the plurality of time periods. The steps can further include performing the creating based on detecting an attack on one or more users. The steps can further include adding domains based on the previously undetected suspicious anomalies to a blocked list. The steps can further include labeling the previously undetected suspicious domains as suspicious for use in training a model to detect suspicious domains. The steps can further include, prior to the receiving, monitoring the plurality of user devices via the cloud-based system; and storing log data for the network transaction data. The steps can further include, prior to the analyzing, assigning a weight to each edge based on a relationship strength in the time period. The steps can further include, prior to the analyzing, detecting a beaconing behavior score on each vertex of the relationship score. The steps can further include, prior to the analyzing, detecting an anomaly score on each vertex of the relationship score.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a cloud-based system offering security as a service.

FIG. 2 is a network diagram of an example implementation of the cloud-based system.

FIG. 3 is a block diagram of a server that may be used in the cloud-based system of FIGS. 1 and 2 or the like.

FIG. 4 is a network diagram of three example network configurations of malicious domain detection between a user (each having a user device) and the Internet.

FIG. 5 is a flow diagram of a domain reputation process that is configured to provide a score of the likelihood a given domain is malicious or benign.

FIG. 6 is a graph of suspicious domains based on their reputation score showing a Gaussian distribution.

FIG. 7 is a diagram of an example kill chain model.

FIG. 8 is a diagram of an example relationship graph.

FIG. 9 is a flowchart of a contextual relationship graph process.

FIG. 10 includes log data for four different users from four different organizations.

### DETAILED DESCRIPTION OF THE DISCLOSURE

Again, the present disclosure relates to systems and methods for a contextual relationship graph based on user's network transaction patterns for investigating attacks. Specifically, the present disclosure utilizes logs from cloud-based monitoring to build contextual relationship graphs to look at user's network transaction patterns. Once an attack is detected, it is possible to go backwards in time and analyze the patter using the relationship graphs.

### Example Cloud-Based System Architecture

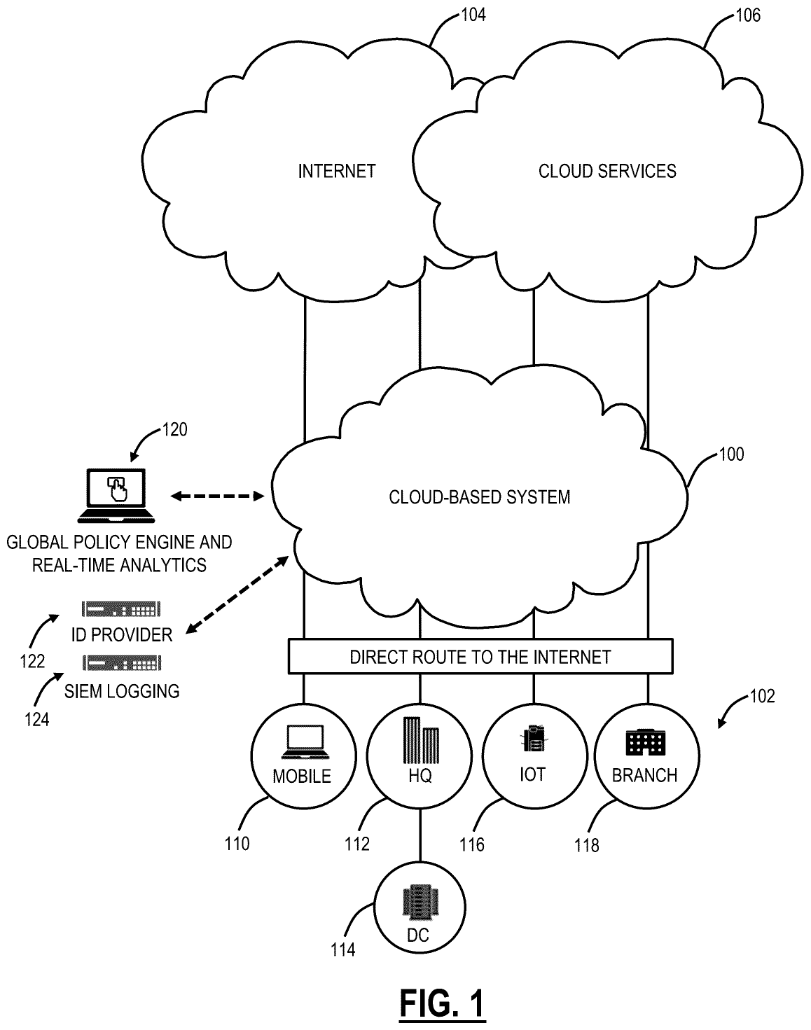

FIG. 1 is a network diagram of a cloud-based system 100 offering security as a service. Specifically, the cloud-based system 100 can offer a Secure Internet and Web Gateway as a service to various users 102, as well as other cloud services. In this manner, the cloud-based system 100 is located between the users 102 and the Internet as well as any cloud services 106 (or applications) accessed by the users 102. As such, the cloud-based system 100 provides inline monitoring inspecting traffic between the users 102, the Internet 104, and the cloud services 106, including Secure Sockets Layer (SSL) traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via Cloud Access Security Broker (CASB), file type control, etc. The traffic inspection applies a variety of security features on the traffic, such as in an ordered manner, with the traffic being allowed if it passes all of the security features.

The cloud-based firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc., protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being in a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

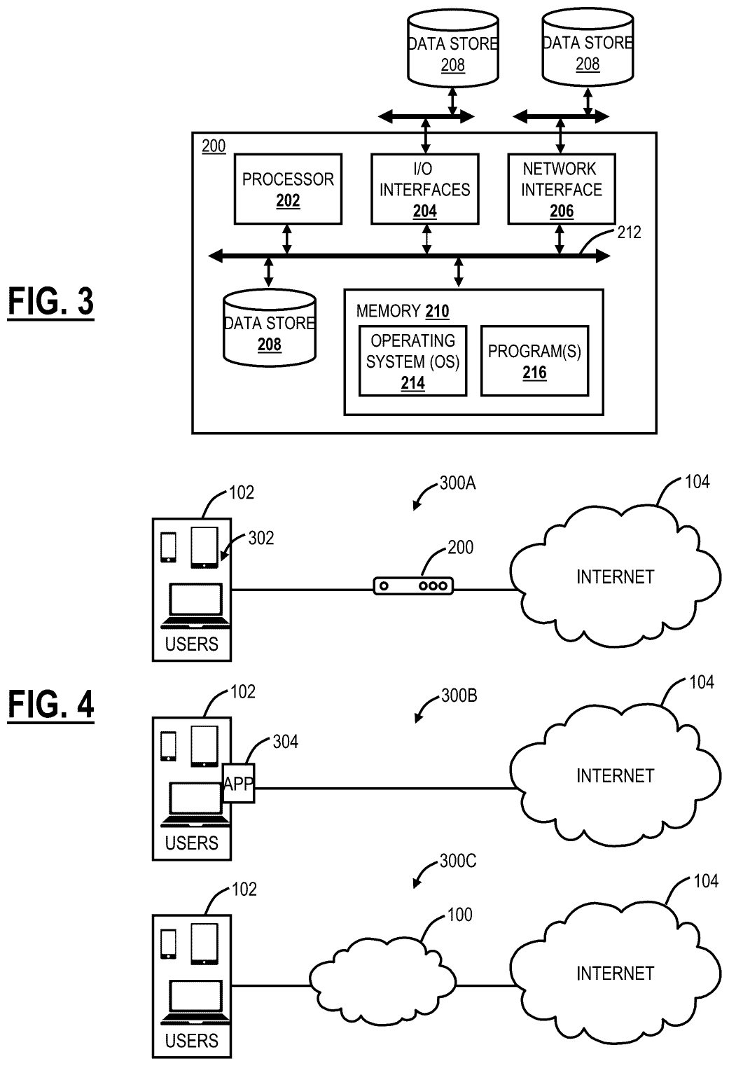

For illustration purposes, the users 102 of the cloud-based system 100 can include a mobile device 110, a headquarters (H.Q.) 112 which can include or connect to a data center (DC) 114, Internet of Things (I) devices 116, a branch office/remote location 118, etc., and each includes one or more user devices (an example user device 300 is illustrated in FIG. 3). The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters 112 can include an enterprise's network with resources in the data center 114. The mobile device 110 can be a so-called road warrior, i.e., users that are off-site, on-the-road, etc.

Further, the cloud-based system 100 can be multi-tenant, with each tenant having its own users 102 and configuration, policy, rules, etc. One advantage of the multi-tenancy and a large volume of users is the zero-day/zero-hour protection in that a new vulnerability can be detected and then instantly remediated across the entire cloud-based system 100. The same applies to policy, rule, configuration, etc. changes—they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 106) and the Internet 104 and the cloud services 106. Previously, the I.T. deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise I.T. administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as Generic Routing Encapsulation (GRE), Layer Two Tunneling Protocol (L2TP), Internet Protocol (I.P.) Security (IPsec), customized tunneling protocols, etc. The devices 110, 116, when not at one of the locations 112, 114, 118 can use a local application that forwards traffic, a proxy such as via a Proxy Auto-Config (PAC) file, and the like. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables I.T. administrators to have a unified view of user activity, threat intelligence, application usage, etc. For example, I.T. administrators can drill-down to a per-user level to understand events and correlate threats, to identify compromised devices, to have application visibility, and the like. The cloud-based system 100 can further include connectivity to an Identity Provider (IDP) 122 for authentication of the users 102 and to a Security Information and Event Management (SIEM) system 124 for event logging. The system 124 can provide alert and activity logs on a per-user 102 basis.

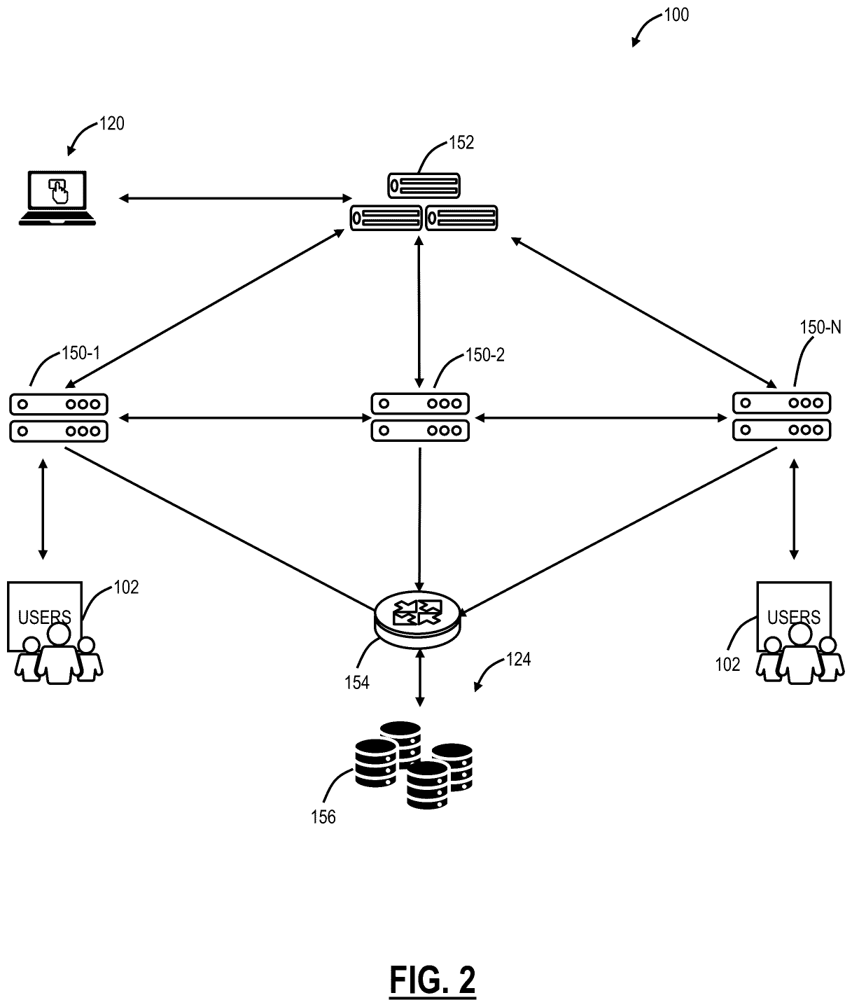

FIG. 2 is a network diagram of an example implementation of the cloud-based system 100. In an embodiment, the cloud-based system 100 includes a plurality of enforcement nodes (EN) 150, labeled as enforcement nodes 150-1, 150-2, 150-N, interconnected to one another and interconnected to a central authority (CA) 152. The nodes 150, 152, while described as nodes, can include one or more servers, including physical servers, virtual machines (V.M.) executed on physical hardware, etc. An example of a server is illustrated in FIG. 2. The cloud-based system 100 further includes a log router 154 that connects to a storage cluster 156 for supporting log maintenance from the enforcement nodes 150. The central authority 152 provides centralized policy, real-time threat updates, etc. and coordinates the distribution of this data between the enforcement nodes 150. The enforcement nodes 150 provide an onramp to the users 102 and are configured to execute policy, based on the central authority 152, for each user 102. The enforcement nodes 150 can be geographically distributed, and the policy for each user 102 follows that user 102 as he or she connects to the nearest (or other criteria) enforcement node 150. Of note, the cloud-based system is an external system meaning it is separate from tenant's private networks (enterprise networks) as well as from networks associated with the devices 110, 116, and locations 112, 118.

The enforcement nodes 150 are full-featured secure internet gateways that provide integrated internet security. They inspect all web traffic bi-directionally for malware and enforce security, compliance, and firewall policies, as described herein. In an embodiment, each enforcement node 150 has two main modules for inspecting traffic and applying policies: a web module and a firewall module. The enforcement nodes 150 are deployed around the world and can handle hundreds of thousands of concurrent users with millions/billions of concurrent sessions. Because of this, regardless of where the users 102 are, they can access the Internet 104 from any device, and the enforcement nodes 150 protect the traffic and apply corporate policies. The enforcement nodes 150 can implement various inspection engines therein, and optionally, send sandboxing to another system. The enforcement nodes 150 include significant fault tolerance capabilities, such as deployment in active-active mode to ensure availability and redundancy as well as continuous monitoring.

In an embodiment, customer traffic is not passed to any other component within the cloud-based system 100, and the enforcement nodes 150 can be configured never to store any data to disk. Packet data is held in memory for inspection and then, based on policy, is either forwarded or dropped. Log data generated for every transaction is compressed, tokenized, and exported over secure TLS connections to the log routers 154 that direct the logs to the storage cluster 156, hosted in the appropriate geographical region, for each organization. In an embodiment, all data destined for or received from the Internet is processed through one of the enforcement nodes 150. In another embodiment, specific data specified by each tenant, e.g., only email, only executable files, etc., is process through one of the enforcement nodes 150.

Each of the enforcement nodes 150 may generate a decision vector D=[d1, d2, . . . , dn] for a content item of one or more parts C=[c1, c2, . . . , cm]. Each decision vector may identify a threat classification, e.g., clean, spyware, malware, undesirable content, innocuous, spam email, unknown, etc. For example, the output of each element of the decision vector D may be based on the output of one or more data inspection engines. In an embodiment, the threat classification may be reduced to a subset of categories, e.g., violating, non-violating, neutral, unknown. Based on the subset classification, the enforcement node 150 may allow the distribution of the content item, preclude distribution of the content item, allow distribution of the content item after a cleaning process, or perform threat detection on the content item. In an embodiment, the actions taken by one of the enforcement nodes 150 may be determinative on the threat classification of the content item and on a security policy of the tenant to which the content item is being sent from or from which the content item is being requested by. A content item is violating if, for any part C=[c1, c2, . . . , cm] of the content item, at any of the enforcement nodes 150, any one of the data inspection engines generates an output that results in a classification of “violating.”

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The enforcement nodes 150 establish persistent connections to the central authority 152 to download all policy configurations. When a new user connects to an enforcement node 150, a policy request is sent to the central authority 152 through this connection. The central authority 152 then calculates the policies that apply to that user 102 and sends the policy to the enforcement node 150 as a highly compressed bitmap.

The policy can be tenant-specific and can include access privileges for users, websites and/or content that is disallowed, restricted domains, DLP dictionaries, etc. Once downloaded, a tenant's policy is cached until a policy change is made in the management system 120. The policy can be tenant-specific and can include access privileges for users, websites and/or content that is disallowed, restricted domains, DLP dictionaries, etc. When this happens, all of the cached policies are purged, and the enforcement nodes 150 request the new policy when the user 102 next makes a request. In an embodiment, the enforcement node 150 exchange “heartbeats” periodically, so all enforcement nodes 150 are informed when there is a policy change. Any enforcement node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud service 106 is any service made available to users on-demand via the Internet, as opposed to being provided from a company's on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), and Zscaler Digital Experience (ZDX), all from Zscaler, Inc. (the assignee and applicant of the present application). The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services 106 are also contemplated. Also, other types of cloud architectures are also contemplated, with the cloud-based system 100 presented for illustration purposes.

### Example Server Architecture

FIG. 3 is a block diagram of a server 200, which may be used in the cloud-based system 100, in other systems, or standalone. For example, the enforcement nodes 150 and the central authority 152 may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Domain Detection System

FIG. 4 is a network diagram of three example network configurations 300A, 300B, 300C of malicious domain detection between a user 102 (each having a user device 302) and the Internet 104. The objective of the malicious domain detection is to identify a URL requested by the user 102 as malicious or benign, and to block and/or flag malicious URLs and allow benign URLs. For example, the malicious URLs can be physically blocked so that the user 102 is unable to access these sites. Alternatively, the malicious URLs can be flagged to the user, e.g., “this site is a potential phishing/malicious site,” allowing the user to proceed with caution. In a further embodiment, the malicious URLs can be loaded in isolation. Those skilled in the art will recognize the example network configurations 300A, 300B, 300C are described herein for illustration purposes and the phishing detection contemplates use in other approaches.

The network configuration 300A includes a server 200 located between the user 102 and the Internet 104. For example, the server 200 can be a proxy, a gateway, a Secure Web Gateway (SWG), Secure Internet and Web Gateway, etc. The server 200 is illustrated located inline with the user 102 and configured to monitor URL requests for malicious domain detection and remediation. In other embodiments, the server 200 does not have to be inline. For example, the server 200 can monitor the URL requests and provide feedback to the user 102 or specific actions to the user device 302. The server 200 can be on a local network associated with the user 102 as well as external, such as on the Internet 104. The network configuration 300B includes an application 304 that is executed on the user device 302. The application 304 can perform the same functionality as the server 200, as well as coordinated functionality with the server 200. Finally, the network configuration 300C includes a cloud service such as through the cloud-based system 100 configured to monitor the user 102 and perform the malicious domain detection. Of course, various embodiments are contemplated herein, including combinations of the network configurations 300A, 300B, 300C together.

The overall objective of the malicious domain detection includes identifying whether or not a URL is a malicious or benign site and allowing/blocking/alerting based thereon. To that end, the malicious domain detection can include the maintenance of a block list that includes all URLs categorized as malicious. The malicious domain detection can add newly categorized sites to this list as well. For example, the application 302 may be a browser add-in or agent that prohibits access to any sites in the list. Also, the cloud-based system 100 can block/allow/isolate requests based on the categorization.

### Machine Learning in Network Security

Machine learning can be used in various applications, including malware detection, intrusion detection, threat classification, the user or content risk, detecting malicious clients or bots, etc. In a particular use case in the present disclosure, machine learning can be used to analyze a new domain. That is, a machine learning model is built and trained as described herein to determine the likelihood a new domain is benign or malicious. As described here, the typical machine learning training process collects data samples with labels (benign or malicious), extracts a set of features from these samples, and feeds the features into a machine learning model to determine patterns. The output of this training process is a machine learning model that can predict the likelihood a new domain is benign or malicious, in production.

### Domain Reputation

An input of the malicious domain detection can be a domain reputation database that includes the categorization of sites. This can also be a service that can classify new domains helping with threat detection to identify if a given domain is likely to be malicious. Note that the word “likely” is emphasized because the focus is on the unknown threats; if a domain is known to be bad (because it was associated with a known threat for example) then it should have been blocked already, i.e., already in the domain reputation database.

An objective of the present disclosure is to determine a reputation score that reflects the likelihood of a good domain (or malicious domain). For example, a score between 0 and 100 with a lower score means more likely to be bad. The reputation score can be used in combination with other techniques as described herein, such as phishing site detection, C2 detection, smart browser isolation, and the like.

There is a need for data, for training and production. Regarding the data, below are some relevant data sources that can be used herewith.

The WHOIS database contains all registered domain names and is publicly available. The WHOIS database includes the contact information of the registrant, nameservers, various dates, and the like.

A passive DNS database includes historical DNS records and may be obtained via third-parties.

One important data source is the logs from the cloud-based system 100, stored in the storage cluster 156. The cloud-based system 100 is multi-tenant and supports the security monitoring of millions of users. For example, the cloud-based system 100 can monitor hundreds of billions of transactions every day for many different tenants (organizations). The storage cluster 156 can contain the browsing history of all of the users 102. This is a large amount of data that can be leveraged in machine learning.

further data source can be external databases of known malicious sites, e.g., threat intelligence feeds, or URLs extracted from known malwares.

### Domain Reputation Flow

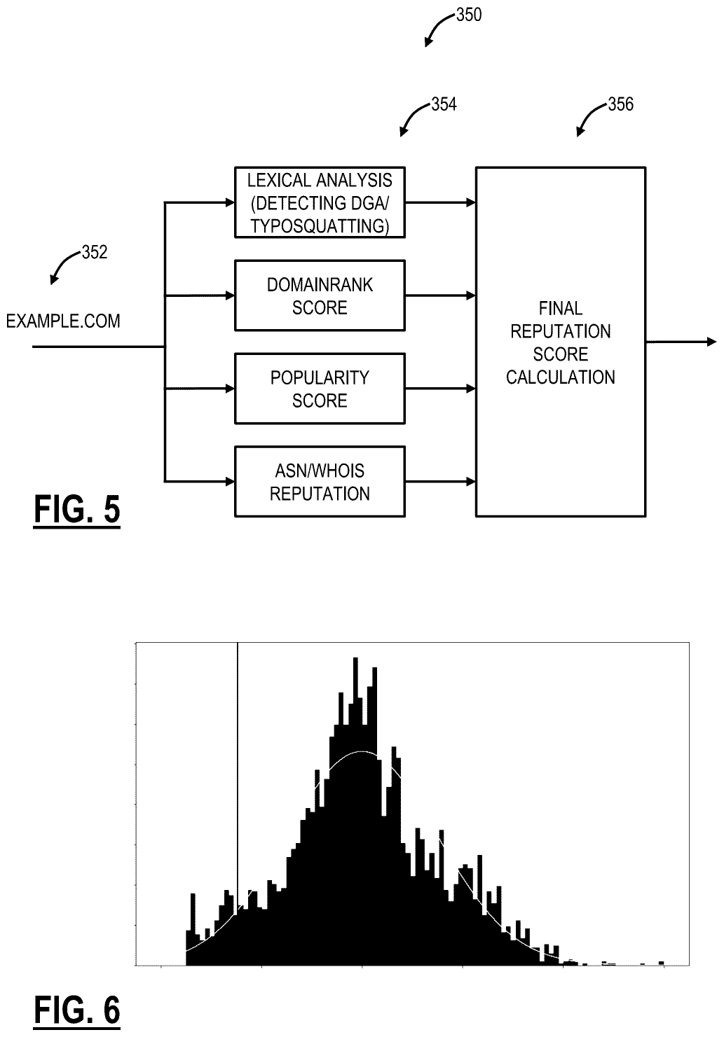

FIG. 5 is a flow diagram of a domain reputation process 350 that is configured to provide a score of the likelihood a given domain 352 is malicious or benign. The domain reputation process 350 receives the domain 352 (e.g., example.com) and analyzes the domain 352 with a plurality of components 354 to calculate a reputation score 356. The components 354 can include lexical analysis (including Domain Generation Algorithm (DGA) detection and typosquatting detection), Domain Rank reputation, popularity reputation, and historical Autonomous System Number (ASN)/WHOIS reputation; then their outputs are combined to get the final reputation score 356.

While DGA and typosquatting detection can be ML models that just do prediction, the other components might involve a database lookup. Of course, the domain reputation process 350 does not have to be limited to only these four components 354, could include a subset of these components 354, could include additional components.

### DGA Detection

The goal of this component is to determine if the domain (or part of the domain) was generated by a Domain Generating Algorithm (DGA). DGA algorithms are seen in various families of malware that are used to periodically generate a large number of domain names that can be used as rendezvous points with their C2 servers. For example, an infected computer could create thousands of domain names such as: www.<gibberish>.com and would attempt to contact a portion of these with the purpose of receiving an update or commands.

DGA domain names can be blocked using blacklists, but the coverage of these blacklists is either poor (public blacklists) or wildly inconsistent (commercial vendor blacklists). Detection techniques belong in two main classes: reactionary and real-time. Reactionary detection relies on non-supervised clustering techniques and contextual information like network NXDOMAIN responses, WHOIS information, and passive DNS to make an assessment of domain name legitimacy. Recent attempts at detecting DGA domain names with deep learning techniques have been extremely successful, with F1 scores of over 99%. These deep learning methods typically utilize Long Short-Term Memory (LSTM) and Convolutional Neural Network (CNN) architectures, though deep word embeddings have shown great promise for detecting dictionary DGA.

DGA detection can be formulated as a ML problem, where the negative labeled data (non-DGA) is obtained from the storage cluster 156 and the positive labeled data (DGA) is obtained from the known DGAs. The cloud-based system 100 has the advantage of having a large data set of non-DGA data, and this can be combined with the positive labeled data (DGA).

### Typosquatting detection

The goal of this component is to determine if the domain (or part of the domain) was a typosquatting one. As is known in the art, typosquatting is where a possibly malicious site mimics a real site through typos, adding letters, combining words, omitting periods, extra periods, appending terms, etc. For example, example.com is a legitimate site where exemple.com could be typosquatting.

Similar to the DGA detection, this can be formulated as an ML problem, where the negative labeled data (non-typosquatting) is obtained from the storage cluster 156 and the positive labeled data (typosquatting) is obtained from some available phishing datasets.

### DomainRank

PageRank is an algorithm used by Google search to rank web pages in search engine results. PageRank works by counting the number and quality of links to a page to determine a rough estimate of how important the website is. The underlying assumption is that more important websites are likely to receive more links from other websites. This is also similar to patent valuation based on the number of future citations, namely the more valuable a patent, the more citations it would have in the future. For example, PageRank is described in U.S. Pat. No. 6,285,999—Sep. 4, 2001, the contents of which are incorporate by reference.

The present disclosure proposes a related concept referred to herein as DomainRank. The idea behind the popularity is that a good reputed domain is good because many users have visited it for quite some time. On the other hand, a bad reputed domain will be bad because of links pointing to known bad domains. Note that the number of domains is much less than the number of web pages and tweaked for the security purpose. That is, the present disclosure can treat each domain (in the WHOIS database) as a node in a graph, then crawl the web and put a directed edge if there is a link from any page of one domain to another domain. Then we run the PageRank algorithm on the graph to get the ranks of the domains and use them as reputation scores. The PageRank algorithm can be adjusted to take into account whether the domain has links pointing to known bad domains. This approach only punishes a domain if it has links pointing to known bad domains, but not the other way around; for example, a phishing site can have links pointing to legitimate domains—those legitimate domains should not be punished by that.

### Popularity

The idea behind the popularity is a good reputed domain is good because many users have visited me for quite some time. Again, using the vast log data of the cloud-based system 100, it is possible to measure the popularity of a domain by counting the number of hits on the domain over time, and use it as the basis for the reputation score. No machine learning is needed here, but some analysis is still needed to decide how to do normalization, how to incorporate the decayed factor, etc. That is, there are two dimensions here—number of hits and time. The time should be valued more in recent time.

### ASN/WHOIS Historical Reputation

The idea behind historical reputation is that a bad reputed domain may be bad if it is associated with an entity that has been involved with malicious activity in the past. The associated entity can be either an ASN or a DNS provider/server or a Domain registrar/registrant. This approach would need the passive DNS and/or malware data to get the statistics. The age of the domain (gotten from WHOIS information) can also be taken into account. Again, no machine learning is needed here, but some analysis is still needed to decide how to do normalization, how to incorporate the decayed factor, etc.

### Final Reputation Score Calculation

The final domain reputation score 356 can be calculated as the combination of some or all of the above components' scores. It is also possible to automatically adjust the weights of these scores to make sure that the final reputation scores follow a Gaussian distribution (as in FIG. 6). This will allow setting a threshold to control the fraction of “suspicious” domains to be sent for further analysis.

### Kill Chain Model

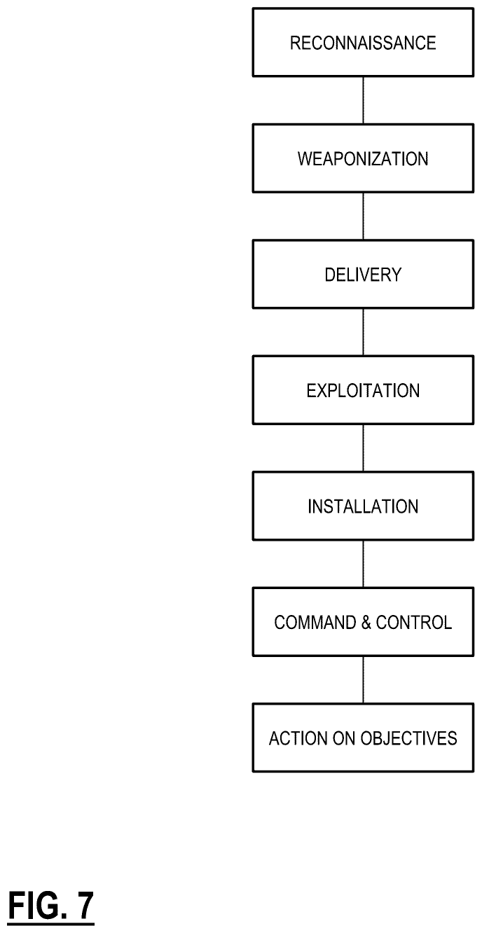

FIG. 7 is a diagram of an example kill chain model. Here are examples that illustrate how a real attack could actually take place:

Reconnaissance: in this phase, attackers begin looking for vulnerabilities in security posture at the target organization, often anonymously from online sources. The breadth of reconnaissance activities may encompass threat actors studying the social media profiles of intended victims, using online tools like Shodan to find possible technology weaknesses in use at the organization, or searching for exposed credentials and assets like encryption keys on GitHub (perhaps accidentally left embedded in code by development teams) or exposed AWS S3 buckets that contain sensitive data. As an example, an attacker may discover the Facebook, LinkedIn, or other social media account of a privileged user who works in the target IT organization, and through online searches discover the user's email address, then use that address to send a phishing email.

Weaponization: weaponization is the development and assembly of exploits and malicious code targeting the intended victim. Depending on the planned method of attack, this may consist of configuring exploitation frameworks like Metasploit, developing phishing email content that includes a malicious attachment or embedded link which directs the user to a malicious online site, and so on. In our phishing example, an attacker might craft a custom email that is purportedly sent from a well-known conference the intended victim might be interested in attending. The email includes an attached document offering an agenda, discounts, or something else enticing. The goal is to get the victim to open the document which contains an embedded exploit.

Delivery: delivery of exploits via email, web, or other vectors is the true beginning of the attack itself. In our example, the attacker sends the spear-phishing email with the attached PDF file to the victim.

Exploitation: exploiting a vulnerability to execute malicious code on a victim's system(s) is the initial step for an attacker. The exploitation could be remote code execution on a server, SQL injection on web application vulnerabilities, or a social engineering victim clicking a link or opening a malicious file. In our scenario, the victim opens the PDF document to check the conference agenda/discounts, and embedded code silently executes on the victim's system,

Installation: installation of malware or code on a victim asset occurs after the exploitation phase completes. The usual goal for an attacker during this stage is to set up a “beachhead” that allows for more control plus a location from which the attacker can initiate later objectives in a campaign. In the scenario we are describing, the code that executes from the malicious PDF file installs a local remote access trojan (RAT) which allows the attacker to remotely execute commands on the victim's system.

Command & Control: after installation of malware or other malicious code, attackers may “phone home” to an online server/service to receive commands oriented toward attack objectives. If the attack involves additional automated malware, this step is usually done automatically after the installation is complete, For interactive attacks, an attacker may simply execute commands or fetch additional tools to aid in later activities. In our scenario, the attacker's malicious code executes automatically after the PDF is opened. The installed RAT then sends the attacker a notification of successful compromise and allows the attacker to assume control of the system.

Action on Objectives: with full control and access to victim systems, attackers begin to carry out the individual stages and goals of their campaign. These will vary by attacker based on their motivations and skill, but these phases usually include gaining access to credentials, sensitive data, and more. In our scenario, the attacker might look to extract the user's credentials, move laterally to another target, access internal file shares, or any other number of nefarious activities.

### Relationship Graph

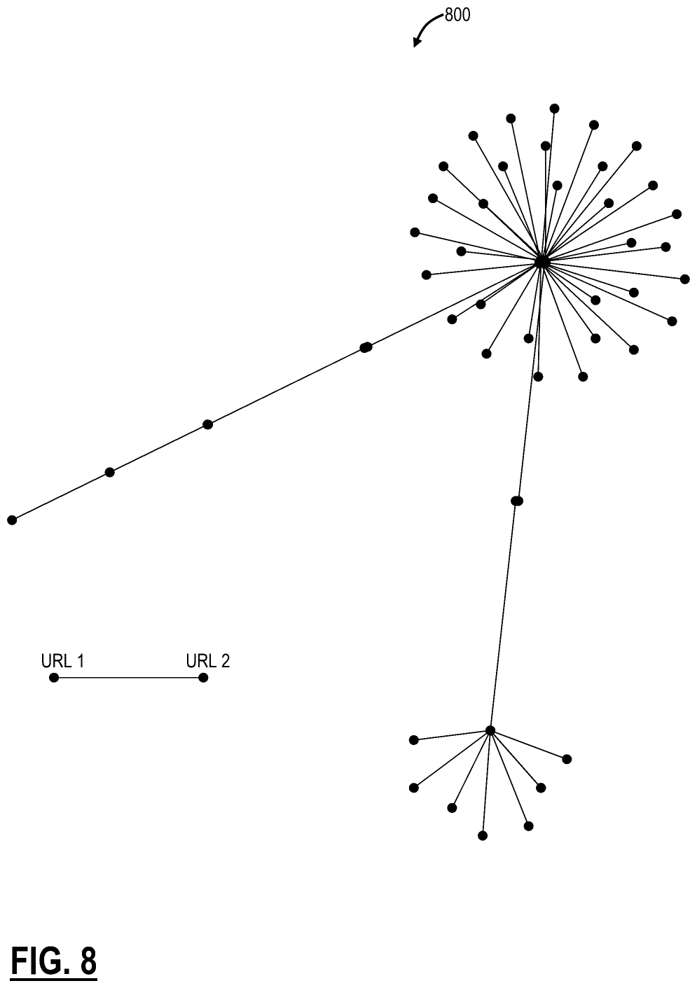

FIG. 8 is a diagram of an example relationship graph 800. The relationship graph 800 is used to display relationships for identifying patterns. Once an attack is detected, it is possible to build the following relationship graphs:

(1) Malware-based relation: in this relation, we say that domain D1 and domain D2 are related because there are malware samples that make connections to both of them. The relationship can be obtained by static or dynamic analysis, such as in a sandbox environment.

(2) IP-based relation: in this relation, we say that domain D1 and domain D2 are related because domain D1 either currently resolves to or at some point in the past resolved to an IP address A, and domain D2 also either currently resolves to or at some point in the past resolved to the same IP address A. The relationship can be obtained via the Passive DNS data.

(3) ASN-based relation: in this relation, we say that domain D1 and domain D2 are related because domain D1 resolves to the IP address A1, and domain D2 resolves to the IP address A2, and both IP addresses A1 and A2 belong to the same Autonomous System Number (ASN). The relationship can be obtained via the data mapping from IP address to ASN.

(4) Registration-based relation: in this relation, we say that domain D1 and domain D2 are related because they share the same domain registration information; for example, the domains were registered on the same date at the same registrar. The relationship can be obtained via the WHOIS data.

(5) Redirecting-based relation: in this relation, we say that domain D1 and domain D2 are related because the web traffic to domain D1 is redirected to domain D2 or vice versa. This includes recent work by Z. Chen and J. Freire, “Discovering and Measuring Malicious URL Redirection Campaigns from Fake News Domains,” 2021 IEEE Security and Privacy Workshops (SPW), 2021, pp. 1-6, doi: 10.1109/SPW53761.2021.00008, the contents of which are incorporated by reference. The relationship can be obtained by web crawling.

The relationship graph 800 is analogous to a detective board (also referred to as an evidence board, etc.). It features a collage of media from different sources, pinned to a pinboard or stuck to a wall, and frequently interconnected with string to mark connections.

### Graph Components

Each graph includes vertices (nodes) and edges. The vertices are domains, such as URLs, etc. The edges are used to model a relationship. In a particular relationship graph 800, the edges are formed between vertices when there is some relationship such as a set number of transactions in a given time period and a value or weight on the edge can define the strength of the relationship. For example, a particular graph 800 can be over some time period (day, hours, etc.) to model the relationships in that time period. Also, it is possible to look at deltas been graphs of successive time periods.

### Contextual Relationship Graph

Of note, the aforementioned relationship graphs are determined with data obtained after the attack is detected. As mentioned herein, it would be advantageous to look back to see what was going on with the compromised victim and other potential victims.

The problem with building a contextual relationship graph is that there is a need for large-scale user network transaction data from multiple users. Advantageously, the cloud-based system 100 with its inline monitoring supports such large-scale user network transaction data, across multiple users, multiple organizations, etc. That is, the present disclosure includes leveraging global, cloud-wise user network access patterns to detect unknown threats. That is, monitoring data from the cloud-based system 100.

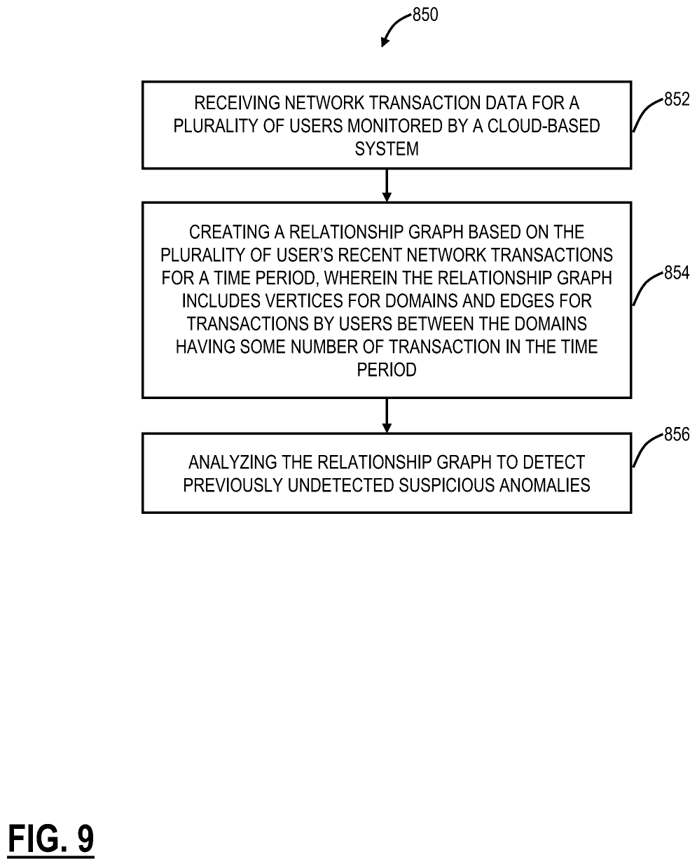

FIG. 9 is a flowchart of a contextual relationship graph process 850. The contextual relationship graph process 850 contemplates implementation as a method, via a server 200, via the cloud-based system 100, and as a non-transitory computer-readable storage medium having computer-readable code stored thereon for programming one or more processors to perform steps. Of note, the contextual relationship graph process 850 utilizes historical transactions logged by the cloud-based system 100, such as stored in the storage cluster 156.

The contextual relationship graph process 850 includes receiving network transaction data for a plurality of users monitored by a cloud-based system (step 852); creating a relationship graph based on the plurality of user's recent network transactions for a time period, wherein the relationship graph includes vertices for domains and edges for transactions by users between the domains having some number of transaction in the time period (step 854); and analyzing the relationship graph to detect previously undetected suspicious anomalies.

The relationship graph is built based on the user's network transaction patterns (context). Roughly speaking, the relation is as follows: we say that domain D1 and domain D2 are related because there were at least a predefined number of users accessing both domains within a predefined time window (hours, minutes, days, etc.). The context relationship graph can also be built as a directed graph in which the before and after relationship is captured by the edge (that is, an edge from domain D1 to domain D2 means that there were at least a predefined number of users accessing D1 before D2 within a predefined time window). Weights on each edge are based on a relationship between two domains where the relationship includes any of malware, Internet Protocol (IP) addresses, Autonomous System Number (ASN), registration, and redirects. Also, each edge can include more than one weight for multiple variables.

The contextual relationship graph process 850 can further include adding the previously undetected suspicious domains to a blocked list, and/or labeling the previously undetected suspicious domains as suspicious for use in training a model to detect suspicious domains.

The contextual relationship graph process 850 can further include, prior to the detecting, monitoring the plurality of user devices via a cloud-based system 100; and storing log data for the plurality of user's network transactions.

The contextual relationship graph process 850 can further include, prior to the detecting, the relationship strength measurements as the edges' weights. The relationship strength between two domains can be measured using Jaccard similarity coefficient (a.k.a. Jaccard index) between the two sets of users accessing two domains respectively.

The contextual relationship graph process 850 can further include, prior to the detecting, the beaconing behavior score on each vertex (domain) of the graph. The calculation of beaconing behavior score is as follows. For each user accessing the domain, we look at the time series of the GET/POST request and response sizes to and from the domain. Then the beaconing behavior score is calculated based on the following factors: (1) the coefficient of variation of the GET response size time series; (2) the coefficient of variation of the POST request size time series; and (3) the output of a gradient-boosted trees model trained on those two time series.

The contextual relationship graph process 850 can further include, prior to the detecting, the user-agent anomaly score on each vertex (domain) of the graph. The calculation of user-agent anomaly score is as follows. For each user accessing the domain, we identify the user's top user-agents by looking at the whole transaction history of that user, then we identify whether the user used the top user-agents to access that domain. The user-agent anomaly score of the domain is calculated based on the fraction of users that did not use their top user-agents to access that domain.

The contextual relationship graph process 850 can further include, prior to the detecting, the URL anomaly score on each vertex (domain) of the graph. The URL anomaly score is calculated based on two factors: (1) the DGA score output by a DGA detection model, indicating whether the domain is DGA-generated; and (2) the URL path suspicious score indicating whether the sub-paths of the URL were commonly seen in known malicious activities.

The contextual relationship graph process 850 can further include, prior to the detecting, other known relationships between domains as presented in the previous section, such as IP-based relationship, ASN-based relationship, registration-based relationship, and redirecting-based relationship. Each of these relationships, if being considered alone, often gives weak suspicious signals. However, combining all of them together yields much higher signal to noise ratio.

The contextual relationship graph analysis (step 854) can utilize graph analysis techniques, including but not limited to Bayesian networks, to assign scores to each vertex in the relationship graph. The relationship graph encompasses all stages of the attack. It is also possible to analyze the graphs based on the evolution of the vertices and the edges, i.e., looking at different graphs over successive time periods. This would give a view of different ways of attacks, for example.

Advantages compared to the IP-based, ASN-based, and registration-based relations include much higher signal to noise ratio (i.e., the noise level is much lower with our approach).

Advantages compared to the malware-based relations include that it works even without the malware samples (e.g., fileless malware, was illustrated by the case study about MageCart).

Advantages compared to all previous methods include each of the previous methods only focus on one particular stage of the cyber kill chain; in contrast, our method was inspired by the sequence of network access in the cyber kill chain. That is, a sequence of contextual relationship graphs can be seen and analyzed over time.

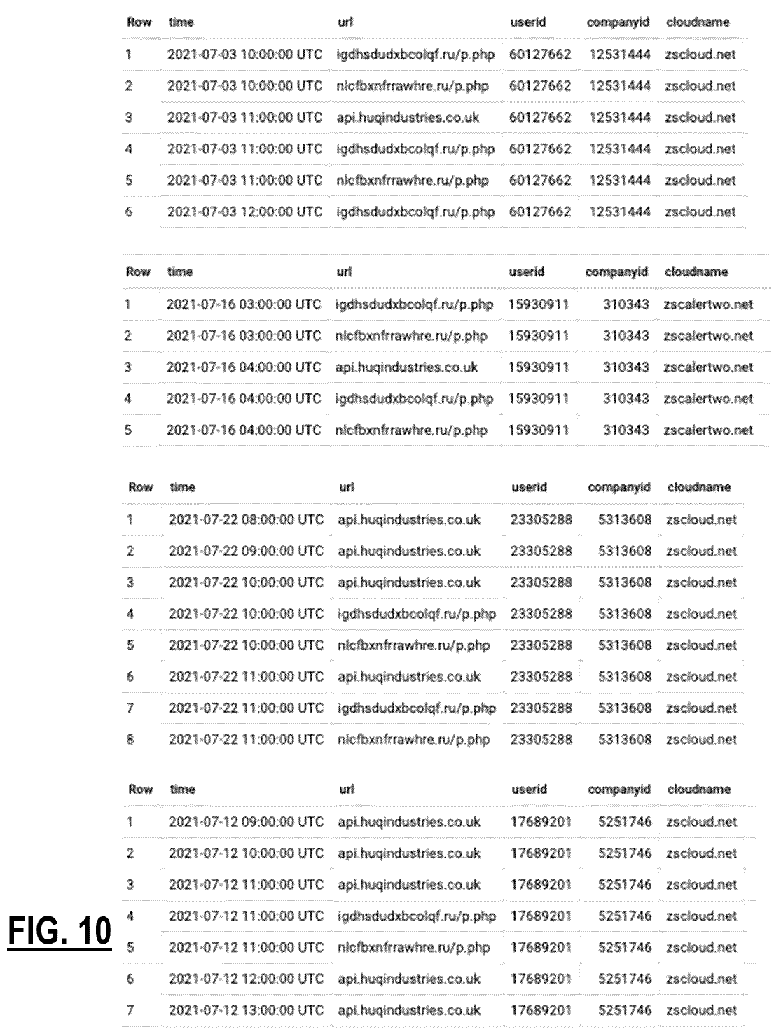

FIG. 10 includes log data for four different users from four different organizations. These each show compromised victims and by graphing the transactions, it is possible to identify other suspicious domains.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read-Only Memory), an EPROM (Erasable Programmable Read-Only Memory), an EEPROM (Electrically Erasable Programmable Read-Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Moreover, it is noted that the various elements, operations, steps, methods, processes, algorithms, functions, techniques, etc. described herein can be used in any and all combinations with each other.

What is claimed is:

1. A non-transitory computer-readable medium comprising instructions that, when executed, cause one or more processors to perform steps of:
receiving network transaction data for a plurality of users monitored by a cloud-based system;
creating a relationship graph based on the plurality of user's recent network transactions for a time period, wherein the relationship graph includes vertices for domains and edges for transactions by users between the domains having some number of transaction in the time period; and
analyzing the relationship graph to detect previously undetected suspicious anomalies.

2. The non-transitory computer-readable medium of claim 1, wherein weights on each edge are based on a relationship between two domains where the relationship includes any of malware, Internet Protocol (IP) addresses, Autonomous System Number (ASN), registration, and redirects.

3. The non-transitory computer-readable medium of claim 1, wherein the steps further include
creating the relationship graph for each of a plurality of time periods; and
analyzing the relationship graph over the plurality of time periods.

4. The non-transitory computer-readable medium of claim 1, wherein the steps further include
performing the creating based on detecting an attack on one or more users.

5. The non-transitory computer-readable medium of claim 1, wherein the steps further include
adding domains based on the previously undetected suspicious anomalies to a blocked list.

6. The non-transitory computer-readable medium of claim 1, wherein the steps further include
labeling the previously undetected suspicious domains as suspicious for use in training a model to detect suspicious domains.

7. The non-transitory computer-readable medium of claim 1, wherein the steps further include
prior to the receiving, monitoring the plurality of user devices via the cloud-based system; and
storing log data for the network transaction data.

8. The non-transitory computer-readable medium of claim 1, wherein the steps further include
prior to the analyzing, assigning a weight to each edge based on a relationship strength in the time period.

9. The non-transitory computer-readable medium of claim 8, wherein the steps further include
prior to the analyzing, detecting a beaconing behavior score on each vertex of the relationship score.

10. The non-transitory computer-readable medium of claim 8, wherein the steps further include
prior to the analyzing, detecting an anomaly score on each vertex of the relationship score.

11. A method comprising steps of:
receiving network transaction data for a plurality of users monitored by a cloud-based system;
creating a relationship graph based on the plurality of user's recent network transactions for a time period, wherein the relationship graph includes vertices for domains and edges for transactions by users between the domains having some number of transaction in the time period; and
analyzing the relationship graph to detect previously undetected suspicious anomalies.

12. The method of claim 11, wherein weights on each edge are based on a relationship between two domains where the relationship includes any of malware, Internet Protocol (IP) addresses, Autonomous System Number (ASN), registration, and redirects.

13. The method of claim 11, wherein the steps further include
creating the relationship graph for each of a plurality of time periods; and
analyzing the relationship graph over the plurality of time periods.

14. The method of claim 11, wherein the steps further include
performing the creating based on detecting an attack on one or more users.

15. The method of claim 11, wherein the steps further include
adding domains based on the previously undetected suspicious anomalies to a blocked list.

16. The method of claim 11, wherein the steps further include
labeling the previously undetected suspicious domains as suspicious for use in training a model to detect suspicious domains.

17. The method of claim 11, wherein the steps further include
prior to the receiving, monitoring the plurality of user devices via the cloud-based system; and
storing log data for the network transaction data.

18. The method of claim 11, wherein the steps further include
prior to the analyzing, assigning a weight to each edge based on a relationship strength in the time period.

19. The method of claim 18, wherein the steps further include
prior to the analyzing, detecting a beaconing behavior score on each vertex of the relationship score.

20. The method of claim 18, wherein the steps further include
prior to the analyzing, detecting an anomaly score on each vertex of the relationship score.
